(19) United States
(12) Patent Application Publication
(10) Pub. No.: US 2025/0365191 A1
(43) Pub. Date: Nov. 27, 2025

(54) VEHICLE TERMINAL, METHOD AND SYSTEM FOR RESETTING VEHICLE TERMINAL, AND VEHICLE INCLUDING VEHICLE TERMINAL

(71) Applicants: Hyundai Motor Company, Seoul (KR); Kia Corporation, Seoul (KR)

(72) Inventor: Jae Yoon KO, Hwaseong-si (KR)

(21) Appl. No.: 18/947,450

(22) Filed: Nov. 14, 2024

(30) Foreign Application Priority Data
May 24, 2024 (KR) 10-2024-0067788

(51) Int. Cl. H04L 41/0668; H04W 4/44

(52) U.S. Cl. CPC H04L 41/0668; H04W 4/44

(57) ABSTRACT

Provided are a vehicle terminal, a method and system for resetting the vehicle terminal, and a vehicle including the vehicle terminal for performing vehicle terminal resetting without user intervention. The vehicle terminal includes a modem connected to a preset communication network, and a processor configured to send a request for resetting a calling number to a communication management server that performs activation of the communication network such that the vehicle terminal is able to use the communication network in response to receiving a preset type of error code from a service server after requesting a service from the service server, receive a reset calling number provided from the communication management server, and change a current calling number to the reset calling number.

### CROSS-REFERENCE TO THE RELATED APPLICATION

The present application claims the benefit of priority under 35 U.S.C. 119 to Korean Patent Application No. 10-2024-0067788, filed on May 24, 2024 in the Korean Intellectual Property Office, the disclosure of which is incorporated herein by reference in its entirety.

### TECHNICAL FIELD

The present disclosure relates to resetting a vehicle terminal, and more specifically, to a vehicle terminal, a method and system for resetting the vehicle terminal, and a vehicle including the vehicle terminal, which can reset a vehicle terminal without user intervention.

### BACKGROUND

Recently, vehicles have been designed to provide various services through communication with servers connected via communication networks. These vehicles, known as “connected cars,” are equipped with vehicle terminals (referred to as connected car terminals) that enable these services.

A vehicle terminal provides services by communicating with a server using a calling number preset by a mobile carrier during the communication network activation process. If the services for the vehicle terminal are canceled, the preset calling number is no longer be used.

When a user wants to activate a service after purchasing a used car, or if a user wishes to subscribe to a paid service after expiration of a free usage period, a new calling number must be assigned to the vehicle terminal for the service to be reactivated.

To set a new calling number, the user must press a service activation button on the vehicle terminal, thereby assigning the new number as the calling number for the terminal. If the user does not press the activation button, the vehicle terminal will be unable to receive services from the server, as the new phone number will not be set. Consequently, this can lead to a deterioration in connected car service quality and reduced customer convenience.

Therefore, there is a need for technology that can reliably reset vehicle terminals without user intervention to enhance service quality and customer convenience.

### BRIEF SUMMARY

The present disclosure is directed to a vehicle terminal, a method and system for resetting the vehicle terminal, and a vehicle including the vehicle terminal, which can improve service quality and customer convenience.

The present disclosure is also directed to a vehicle terminal, a method and system for resetting the vehicle terminal, and a vehicle including the vehicle terminal, which can reset the vehicle terminal without user intervention.

The present disclosure is also directed to a vehicle terminal, a method and system for resetting the vehicle terminal, and a vehicle including the vehicle terminal, which can reset the vehicle terminal through communication with a communication management server when the vehicle terminal receives an error code after requesting a service from a service server.

The present disclosure is also directed to a vehicle terminal, a method and system for resetting the vehicle terminal, and a vehicle including the vehicle terminal, which can request a service again after resetting the vehicle terminal.

According to one aspect of the present disclosure, a vehicle terminal can be a vehicle terminal mounted to a vehicle, including a modem connected to a preset communication network, and a processor configured to send a request for resetting a calling number to a communication management server that performs activation of the communication network such that the vehicle terminal is able to use the communication network in response to receiving a preset type of error code from a service server after requesting a service from the service server, receive a reset calling number provided from the communication management server, and change a current calling number to the reset calling number.

In some implementations, the preset type of error code can include an error code corresponding to a calling number mismatch.

In some implementations, the processor can be configured to provide a vehicle identification number of the vehicle when sending the request for resetting the calling number.

In some implementations, the processor can be configured to reset the modem in response to receiving the error code and send the request for resetting the calling number to the communication management server using the reset modem.

In some implementations, the processor can be configured to change the current calling number to the reset calling number and then request a service from the service server using the reset calling number and the vehicle identification number.

According to another aspect of the present disclosure, a method of resetting a vehicle terminal by resetting a calling number preset for a vehicle terminal mounted to a vehicle can include requesting, by the vehicle terminal, a service from a service server, receiving, by the vehicle terminal, a preset type of error code from the service server, sending, by the vehicle terminal, a request for resetting the calling number to a communication management server, receiving, by the vehicle terminal, a reset calling number provided from the communication management server, and changing, by the vehicle terminal, a current calling number to the reset calling number.

In some implementations, the requesting a service can include providing, by the vehicle terminal, a vehicle identification number of the vehicle while requesting the service using the current calling number.

In some implementations, the method of resetting a vehicle terminal can further include, by the service server, searching for a prestored calling number based on the vehicle identification number in response to receiving a service request, comparing the current calling number with the prestored calling number, and transmitting the error code in response to determining that the current calling number and the prestored calling number do not match.

In some implementations, the sending a request for resetting can include providing the vehicle identification number of the vehicle.

In some implementations, the method of resetting a vehicle terminal can further include, by the communication management server, searching a vehicle identification number-calling number look-up table based on the vehicle identification number and providing a prestored reset calling number matching the vehicle identification number to the vehicle terminal.

In some implementations, the method of resetting a vehicle terminal can further include, before the requesting, by the vehicle terminal, a service from a service server, sending, by the service server, a request for resetting a calling number related to the vehicle terminal to the communication management server in response to a service subscription/activation request, resetting, by the communication management server, a calling number preset for the vehicle terminal in response to the resetting request from the service server, and providing, by the communication management server, the reset calling number to the service server.

In some implementations, the sending a request for resetting a calling number related to the vehicle terminal can include providing the vehicle identification number of the vehicle, and the resetting may include matching the reset calling number with the vehicle identification number and storing the matched reset calling number and vehicle identification number by the communication management server.

In some implementations, the method of resetting a vehicle terminal can further include, by the service server, matching the reset calling number provided from the communication management server with the vehicle identification number and storing the matched reset calling number and vehicle identification number.

According to another aspect of the present disclosure, a system for resetting a vehicle terminal for resetting a calling number preset for a vehicle terminal mounted to a vehicle can include a service server configured to determine validity of a service request in response to receiving the service request from the vehicle terminal and transmit a preset type of error code to the vehicle terminal in response to determining that the service request is invalid, and a communication management server configured to reset a calling number preset for the vehicle terminal in response to receiving a request for resetting a calling number from the vehicle terminal and provide the reset calling number to the vehicle terminal.

In some implementations, the vehicle terminal can be configured to send a request for resetting the calling number to the communication management server in response to receiving the error code from the service server, and change a current calling number to the reset calling number provided from the communication management server.

In some implementations, the vehicle terminal can be configured to provide a vehicle identification number of the vehicle while requesting a service from the service server using the current calling number.

In some implementations, the service server can be configured to search for a prestored calling number based on the vehicle identification number, compare the current calling number with the prestored calling number, and transmit the error code in response that the current calling number and the prestored calling number do not match.

In some implementations, the vehicle terminal can be configured to provide the vehicle identification number of the vehicle while sending a request for resetting the calling number to the communication management server, and the communication management server may be configured to search a vehicle identification number-calling number look-up table based on the vehicle identification number and provide a prestored reset calling number matching the vehicle identification number to the vehicle terminal.

In some implementations, the system for resetting a vehicle terminal can further include a user terminal configured to send a request for service subscription/activation for the vehicle terminal to the service server.

In some implementations, the service server can be configured to send a request for resetting the calling number related to the vehicle terminal to the communication management server in response to the service subscription/activation request, and the communication management server may be configured to reset a calling number preset for the vehicle terminal in response to the resetting request from the service server and provide the reset calling number to the service server.

According to another aspect of the present disclosure, a vehicle can include a vehicle terminal communicating with a service server and a communication management server, wherein, in response to receiving a preset type of error code from the service server after requesting a service from the service server, the vehicle terminal may be configured to send a request for resetting a calling number to the communication management server, receive a reset calling number provided from the communication management server, and change a current calling number to the reset calling number.

### BRIEF DESCRIPTION OF THE DRAWINGS

FIG. 1 is a diagram illustrating an example of a system for resetting a vehicle terminal.

FIG. 2 is a flowchart illustrating an example of a method of resetting a vehicle terminal.

FIG. 3 is a diagram illustrating an example of interactions between components according to the step-by-step operation shown in FIG. 2.

FIG. 4 is a flowchart illustrating an example of a calling number resetting process performed between a vehicle terminal and a communication management server.

FIG. 5 is a diagram illustrating an example of an interaction between the vehicle terminal and the communication management server according to the step-by-step operation shown in FIG. 4.

FIG. 6 is a diagram illustrating an example of the vehicle terminal.

FIG. 7 is a diagram illustrating an example of a service server.

### DETAILED DESCRIPTION

Hereinafter, a vehicle terminal, a method and system for resetting the vehicle terminal, and a vehicle including the vehicle terminal of the present disclosure will be described with reference to the attached drawings.

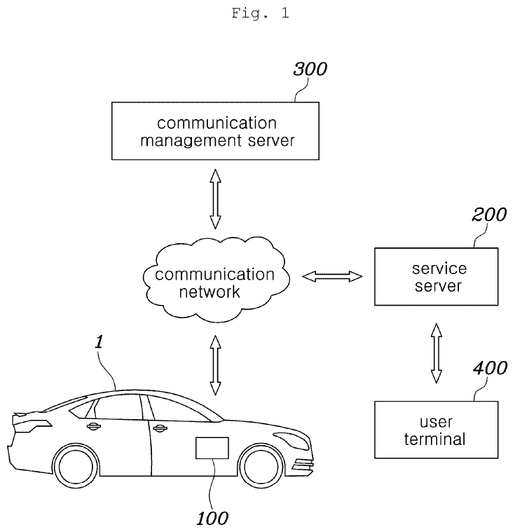

FIG. 1 is a diagram showing an example of a system for resetting a vehicle terminal.

Referring to FIG. 1, the system for resetting a vehicle terminal (hereinafter, referred to as a system) can include a vehicle terminal 100 mounted to a vehicle 1, a service server (or a first server or a connected car server) 200, a communication management server (or a second server) 300, and a user terminal 400, but the configuration of the system is not limited thereto. For example, the service server 200 and the communication management server 300 can be implemented to perform network functionalities in cloud environments.

In the present disclosure, the vehicle 1 may be connected to a communication network to receive streaming of various types of information (road information, traffic information, driving routes, map information, weather information, etc.), multimedia (e.g., music, video, etc.) from the service server 200 and the like. For example, the vehicle 1 may be represented as a “connected car”.

The vehicle terminal 100 is mounted to the vehicle 1 and is a device that provides multimedia functions, navigation functions, communication functions, etc., and may be represented as a “connected car terminal”, for example. For example, the vehicle terminal 100 may be implemented as an audio/video/navigation/telematics (AVNT) system, and the type of the vehicle terminal 100 is not limited thereto.

The vehicle terminal 100 may operate in association with the service server 200 and the communication management server 300.

In some implementations, the vehicle terminal 100 may provide various services to a user by requesting a service from the service server 200 and outputting the service provided from the service server 200 through a pre-implemented user interface.

Here, the vehicle terminal 100 may request a service using a preset calling number. The vehicle terminal 100 may provide the vehicle identification number of the vehicle 1 at the time of requesting a service.

That is, the vehicle terminal 100 may request a service using the preset calling number and also provide the vehicle identification number.

When the vehicle terminal 100 receives a preset error code from the service server 200, the vehicle terminal 100 may store (or retain) the error code and reset (or change) setting information in association with the communication management server 300.

For example, the error code is a preset type of error code and may include an error code corresponding to calling number mismatch.

In some implementations, the vehicle terminal 100 may reset the calling number (or phone number) with respect to the vehicle terminal 100 in association with the communication management server 300. Here, the calling number may be used for authentication of the vehicle terminal 100 when the vehicle terminal 100 operates in association with the service server 200.

For example, the vehicle terminal 100 may provide the vehicle identification number of the vehicle 1 while sending a request for calling number resetting to the communication management server 300, and reset a calling number provided from the communication management server 300 as the calling number for the vehicle terminal 100.

The vehicle terminal 100 communicates with the service server 200 using a modem, and the calling number may be represented as a “terminal calling number” or “modem calling number”. That is, in some implementations, a calling number, a terminal calling number, and a modem calling number mean the same information.

In some implementations, when a terminal reset is input through a user interface, the vehicle terminal 100 may reset the calling number for the vehicle terminal 100 in association with the communication management server 300.

For example, the vehicle terminal 100 may provide the vehicle identification number of the vehicle 1 while sending a request for resetting the vehicle terminal 100 to the communication management server 300. The vehicle terminal 100 may reset the calling number for the vehicle terminal 100 using a calling number provided from the communication management server 300 in response to the request for resetting.

The service server 200 may operate in association with the vehicle terminal 100, the communication management server 300, and the user terminal 400.

In some implementations, the service server 200 may reset the calling number for the vehicle terminal 100 in association with the communication management server 300.

For example, when the service server 200 receives a service subscription and activation request from the user terminal 400, the service server 200 may reset the calling number for the vehicle terminal 100 in association with the communication management server 300.

The service server 200 may receive the vehicle identification number of the vehicle 1 and user terminal information (e.g., a phone number and the like) in response to receiving a service subscription and activation request from the user terminal 400.

The service server 200 may provide the vehicle identification number of the vehicle 1 to the communication management server 300 while requesting service activation for the vehicle terminal 100. The service server 200 may store a calling number reset and provided by the communication management server 300 by matching the same with the vehicle identification number.

For example, the service server 200 may store a look-up table (LUT) including a calling number for each vehicle identification number (hereinafter referred to as a vehicle identification number-calling number look-up table).

In some implementations, the service server 200 resets the calling number by operating in association with the communication management server 300 and then sends a request for resetting the vehicle terminal 100 to the user terminal 400 such that the user manipulates the vehicle terminal 100 to reset the vehicle terminal 100.

In some implementations, in response to receiving a service request from the vehicle terminal 100, the service server 200 may provide a preset service to the vehicle terminal 100.

Here, the service server 200 may receive the vehicle identification number of the vehicle 1 along with the service request from the vehicle terminal 100.

In response to receiving the service request, the service server 200 may search the vehicle identification number-calling number look-up table based on the vehicle identification number, and if the calling number at the time of the service request matches the preset calling number, provide a service to the vehicle terminal 100.

If the calling number at the time of the service request does not match the preset calling number, the service server 200 may transmit an error code to the vehicle terminal 100 using the calling number.

The communication management server 300 may operate in association with the vehicle terminal 100 and the service server 200.

In some implementations, the communication management server 300 may reset the calling number for the vehicle terminal 100 in association with the service server 200.

The communication management server 300 may receive an activation request for the vehicle terminal 100 from the service server 200, reset the calling number for the vehicle terminal 100, and transmit the reset calling number to the service server 200.

The communication management server 300 may receive the vehicle identification number of the vehicle 1 along with the activation request for the vehicle terminal 100 from the service server 200.

In some implementations, service activation for the vehicle terminal 100 is reactivated after service cancellation, and the communication management server 300 stores a preset calling number matched with the vehicle identification number.

In this respect, the communication management server 300 may be regarded as resetting the calling number for the vehicle terminal 100, and the reset calling number may be stored by being matched with the vehicle identification number.

For example, the communication management server 300 may match the reset calling number with the vehicle identification number and store the same in the form of a look-up table.

In some implementations, the communication management server 300 may operate in association with the vehicle terminal 100 to allow the vehicle terminal 100 to reset the calling number.

Resetting of the calling number for the vehicle terminal 100 is performed between the communication management server 300 and the vehicle terminal 100 in a case where resetting of the calling number for the vehicle terminal 100 is not normally performed between the vehicle terminal 100 and the service server 200, a case where resetting has not been performed by the user, and the like.

The communication management server 300 may receive a request for resetting the vehicle terminal 100 from the vehicle terminal 100. Here, the communication management server 300 may provide the vehicle identification number of the vehicle 1 along with the resetting request.

In response to receiving the resetting request from the vehicle terminal 100, the communication management server 300 may reset the calling number matched to the vehicle identification number provided along with the resetting request and provide the reset calling number to the vehicle terminal 100.

The user terminal 400 may send a request for service subscription and activation to the service server 200 according to user operation.

In some implementations, the user terminal 400 may provide the vehicle identification number of the vehicle 1 and user terminal information (e.g., phone number and the like) while requesting service subscription and activation.

The user terminal 400 may receive a request for resetting the vehicle terminal 100 from the service server 200.

The user terminal 400 may output the request for resetting through a user interface using a preset method.

For example, the user terminal 400 may output a modal dialog on the user interface, output a text notification or text, output an e-mail reception notification, or output notification vibration, but the method of outputting a request for resetting by the user terminal 400 is not limited thereto.

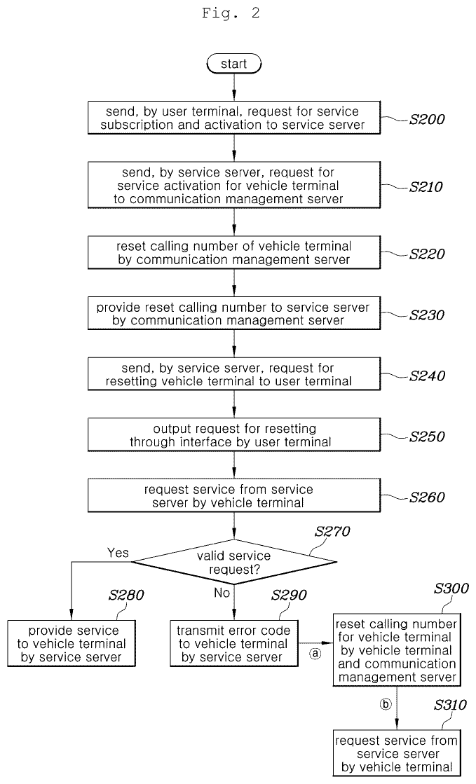

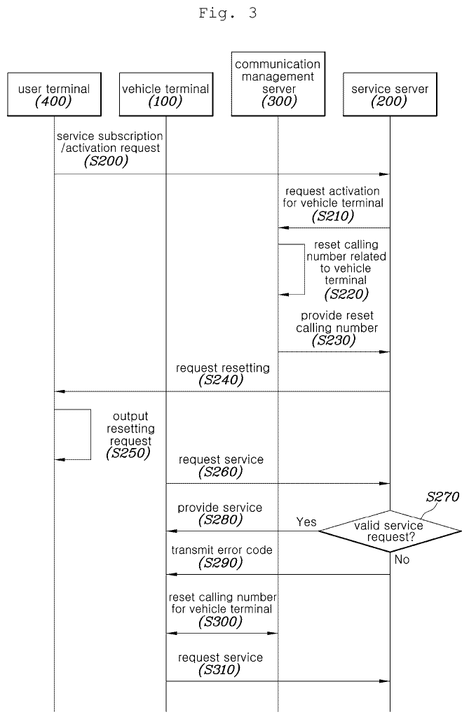

FIG. 2 is a flowchart illustrating an example of a method of resetting a vehicle terminal, and FIG. 3 is a diagram showing interaction between components according to the step-by-step operation shown in FIG. 2.

Referring to FIG. 2 and FIG. 3, the user terminal 400 may send a request for service subscription and activation to the service server 200 according to user operation (S200).

In step S200, the user terminal 400 may provide the vehicle identification number of the vehicle 1 and user terminal information (e.g., phone number and the like) while requesting service subscription and activation.

In response to receiving the service subscription and activation request from the user terminal 400, the service server 200 may send a request for service activation for the vehicle terminal 100 to the communication management server 300 (S210).

In step S210, the service server 200 may provide the vehicle identification number of the vehicle 1 while sending the request for service activation for the vehicle terminal 100 to the communication management server 300.

In response to receiving the request for service activation for the vehicle terminal 100 from the service server 200, the communication management server 300 may reset a preset calling number related to the vehicle terminal 100 (S220) and provide the reset calling number to the service server 200 (S230).

In step S220, the communication management server 300 may match the reset calling number with the vehicle identification number of the vehicle 1 and store the same.

In response to receiving the reset calling number for the vehicle terminal 100 in step S230, the service server 200 can match the reset calling number with the vehicle identification number of the vehicle 1 and store the same.

In response to receiving the reset calling number for the vehicle terminal 100 in step S230, the service server 200 may send a request for resetting the vehicle terminal 100 to the user terminal 400 (S240).

In response to receiving the resetting request in step S240, the user terminal 400 may output the resetting request through the user interface (S250).

Thereafter, the vehicle terminal 100 may request a service from the service server 200 according to user operation (S260).

In step S260, the vehicle terminal 100 requests the service from the service server 200 using the preset calling number, and may also provide the vehicle identification number of the vehicle 1 at the time of requesting the service.

In response to receiving the service request from the vehicle terminal 100, the service server 200 may determine the validity of the service request (S270).

In step S270, the service server 200 may determine the validity of the service request based on the calling number used by the vehicle terminal 100 at the time of requesting the service and the vehicle identification number of vehicle 1 provided from the vehicle terminal 100 at the time of requesting the service.

For example, the service server 200 may search the vehicle identification number-calling number look-up table based on the provided vehicle identification number and determine whether the calling number at the time of requesting the service matches the preset calling number to determine the validity of the service request.

If it is determined that the service request is valid (S270—Yes), the service server 200 may provide the service to the vehicle terminal 100 (S280).

If it is determined that the service request is invalid (S270—No), the service server 200 may transmit an error code to the vehicle terminal 100 (S290).

In response to receiving the error code from the service server 200 in step S290, the vehicle terminal 100 may reset the calling number for the vehicle terminal 100 in association with the communication management server 300 (S300).

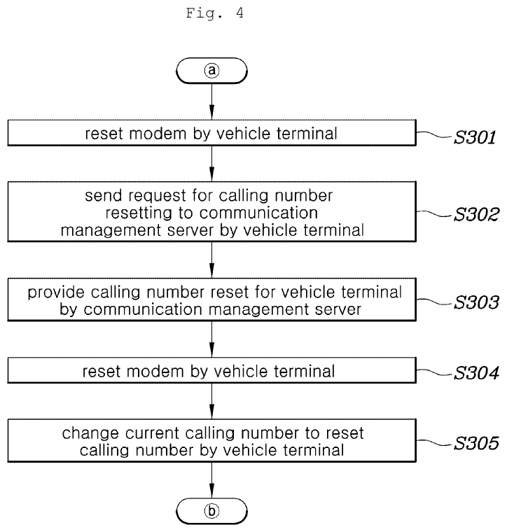

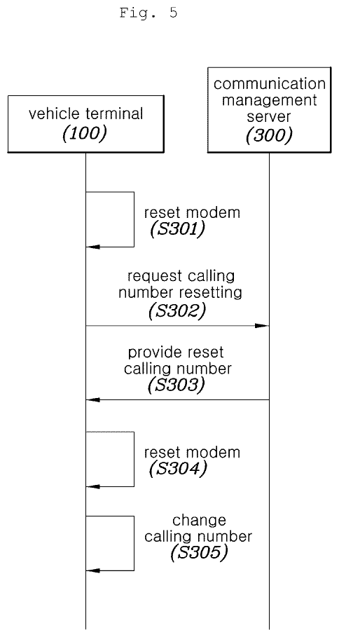

Resetting of the calling number (S300) performed between the vehicle terminal 100 and the communication management server 300 will be described with reference to FIG. 4 and FIG. 5.

In response to completion of resetting of the calling number between the vehicle terminal 100 and the communication management server 300 (S300), the vehicle terminal 100 may request the service from the service server 200 (S310).

FIG. 4 is a flowchart illustrating the calling number resetting process (S300) performed between the vehicle terminal 100 and the communication management server 300, and FIG. 5 shows an interaction between the vehicle terminal 100 and the communication management server 300.

Referring to FIG. 4 and FIG. 5, the vehicle terminal 100 may send a request for calling number resetting to the communication management server 300 (S302).

The vehicle terminal 100 may reset a modem before sending the request for calling number resetting to the communication management server 300 (S301). For example, the vehicle terminal 100 may send the request for calling number resetting to the communication management server 300 after resetting the modem. For example, when the modem of the vehicle terminal 100 is reset, the request for calling number resetting may be sent to the communication management server 300 through the modem of the vehicle terminal 100.

In step S302, the vehicle terminal 100 may provide the vehicle identification number of the vehicle 1 while sending the request for calling number resetting to the communication management server 300.

In response to receiving the request for calling number resetting, the communication management server 300 may transmit a calling number reset for the vehicle terminal 100 to the vehicle terminal 100 based on the vehicle identification number of the vehicle 1 provided at the time of the calling number resetting request (S303).

Here, the calling number reset for the vehicle terminal 100 may be a calling number reset by the communication management server 300 at the request of the service server 200 in step S210.

In some implementations, the communication management server 300 can reset the calling number for the vehicle terminal 100 in association with the service server 200 (S220), match the reset calling number with the vehicle identification number of the vehicle 1 provided from the service server 200, and store the same in the form of a look-up table.

In step S303, the communication management server 300 may search the vehicle identification number-calling number look-up table based on the vehicle identification number provided at the time of requesting calling number resetting in step S302, and provide a searched calling number to the vehicle terminal 100 as a reset calling number.

In response to receiving the reset calling number from the communication management server 300, the vehicle terminal 100 may change the current calling number thereof to the reset calling number received from the communication management server 300 (S305).

In response to receiving the reset calling number from the communication management server 300, the vehicle terminal 100 may reset the modem (S304). For example, the vehicle terminal 100 may reset the modem and then change the current calling number to the reset calling number provided from the communication management server 300.

In this manner, the vehicle terminal 100 may reset the calling number for the vehicle terminal 100 through communication with the communication management server 300 in response to receiving an error code after requesting a service from the service server 200.

Therefore, by using the vehicle terminal resetting technique, customer convenience can be improved because the vehicle terminal 100 can be reset without user intervention.

In addition, since the vehicle terminal 100 requests a service again after resetting, the service can be stably provided and service quality can be improved.

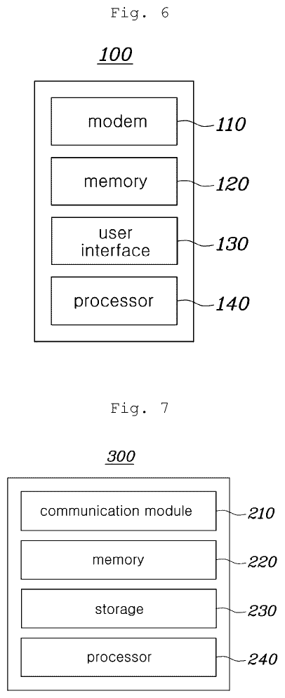

FIG. 6 is a diagram showing an example of the vehicle terminal 100.

Referring to FIG. 6, the vehicle terminal 100 may include a modem 110, a memory 120, a user interface 130, and a processor 140, but the configuration of the vehicle terminal 100 is not limited thereto.

The modem 110 may communicate with the service server 200 and communicate with the communication management server 300. For example, the modem 110 may communicate with the service server 200 and the communication management server 300 through a wireless communication network activated by the communication management server 300.

The modem 110 may communicate with the service server 200 using a preset calling number. The modem 110 may store the calling number used for communication.

For example, the modem 110 may be reset under the control of the processor 140, transmit a service request received from the processor 140 to the service server 200, and transmit a calling number resetting request received from the processor 140 to the communication management server 300.

For example, for communication networks, wireless Internet technologies such as a wireless LAN (WLAN) (Wi-Fi), wireless broadband (WiBro), and/or world interoperability for microwave access (WiMax), short-range communication technologies such as Bluetooth, near field communication (NFC), radio frequency identification (RFID), and/or infrared data association (IrDA), and/or mobile communication technologies such as code division multiple access (CDMA), global system for mobile communication (GSM), and long term evolution (LTE), LTE-Advanced, and/or international mobile telecommunication (IMT)-2020 may be used.

The memory 120 may store software programmed such that the processor 140 may perform a predetermined operation.

The memory 120 may be implemented as at least one storage medium (recording medium) among a flash memory, a hard disk, a secure digital card (SD card), a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and a web storage.

Additionally, the memory 120 may store information received through the modem 110. For example, the memory 120 may store outgoing calls for communication.

The user interface 130 may include various input/output components such that the vehicle terminal 100 can function as a connected car terminal. For example, the user interface 130 may provide various types of services provided from the service server 200.

The user interface 130 may be implemented to receive user operation. For example, the user interface 130 may include a terminal reset button.

The processor 140 may perform operations or data processing related to control of at least one of other components of the vehicle terminal 100. For example, the processor 140 may execute software stored in the memory 120.

The processor 140 may process received data and data stored in the memory 120. The processor 140 may execute computer-readable code (e.g., an algorithm) stored in the memory 120 and instructions triggered by the processor 140.

The processor 140 may be a data processing device implemented as hardware having a circuit with a physical structure for executing desired operations. For example, the desired operations may include code or instructions included in a program.

For example, data processing devices implemented as hardware may include a microprocessor, a central processing unit, a processor core, a multi-core processor, a multiprocessor, an application-specific integrated circuit (ASIC), and a field programmable gate array (FPGA).

In some implementations, the processor 140 can communicate with the service server 200 and the communication management server 300 through the modem 110. The processor 140 may output a service provided from the service server 200 through the user interface 130. The processor 140 may reset a calling number in association with the communication management server 300.

FIG. 7 is a diagram showing an example of the service server 200.

Referring to FIG. 7, the service server 200 may include a communication module 210, a memory 220, a storage 230, and a processor 240, but the configuration of the service server 200 is limited thereto.

The communication module 210 may communicate with the vehicle terminal 100, the service server 200, and the user terminal 400 through a preset wireless communication network.

For example, for communication networks, wireless Internet technologies such as a wireless LAN (WLAN) (Wi-Fi), wireless broadband (WiBro), and/or world interoperability for microwave access (WiMax), short-range communication technologies such as Bluetooth, near field communication (NFC), radio frequency identification (RFID), and/or infrared data association (IrDA), and/or mobile communication technologies such as code division multiple access (CDMA), global system for mobile communication (GSM), and long term evolution (LTE), LTE-Advanced, and/or international mobile telecommunication (IMT)-2020 may be used.

The memory 220 may store software programmed such that the processor 240 may perform a predetermined operation.

The memory 220 may be implemented as at least one storage medium (recording medium) among a flash memory, a hard disk, a secure digital card (SD card), a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and a web storage.

Additionally, the memory 220 may match a calling number (a reset calling number if reset) related to the vehicle terminal 100 with the vehicle identification number and store the same. For example, the memory 220 may store the calling number and the vehicle identification number in the form of a look-up table.

The storage 230 may store service-related information to be provided to the vehicle terminal 100.

The processor 240 may perform operations or data processing related to control of at least one of other components of the service server 200. For example, the processor 240 may execute software stored in the memory 220.

The processor 240 may process received data and data stored in the memory 220. The processor 240 may execute computer-readable code (e.g., an algorithm) stored in the memory 220 and instructions triggered by the processor 240.

The processor 240 may be a data processing device implemented as hardware having a circuit with a physical structure for executing desired operations. For example, the desired operations may include code or instructions included in a program.

For example, data processing devices implemented as hardware include a microprocessor, a central processing unit, a processor core, a multi-core processor, a multiprocessor, an application-specific integrated circuit (ASIC), and a field programmable gate array (FPGA).

In some implementations, the processor 240 can perform subscription to a service related to the vehicle terminal 100 in response to a service subscription/activation request from the user terminal 400, activate a communication network for the vehicle terminal 100 in association with the communication management server 300, and reset the calling number for the vehicle terminal 100.

In some implementations, the processor 240 can provide a service to the vehicle terminal 100 based on information stored in the storage 230 in response to a service request from the vehicle terminal 100. In response to receiving a service request, the processor 240 may search the vehicle identification number-calling number look-up table based on the vehicle identification number, and if the calling number at the time of the service request matches the preset calling number, provide the service to the vehicle terminal 100.

The vehicle terminal can be reset without user intervention by using the vehicle terminal resetting technique to improve customer convenience.

Additionally, since the vehicle terminal requests a service again after being reset, the service can be provided stably and service quality can be improved.

What is claimed is:

1. A vehicle terminal disposed at a vehicle, the vehicle terminal comprising:
a modem operably connected to a preset communication network; and
a processor configured to:
transmit, to a communication management server configured to perform activation of the communication network, a request for resetting a calling number to thereby enable the vehicle terminal to operably connect to the communication network in response to receiving, from a service server, a preset type of error code after requesting a service to the service server,
receive a reset calling number from the communication management server, and
change a current calling number to the reset calling number.

2. The vehicle terminal of claim 1, wherein the preset type of error code includes an error code corresponding to a calling number mismatch.

3. The vehicle terminal of claim 1, wherein the processor is configured to provide a vehicle identification number of the vehicle when the request for resetting the calling number is sent.

4. The vehicle terminal of claim 1, wherein the processor is configured to, based on the error code being received, reset the modem and transmit, to the communication management server using the modem, the request for resetting the calling number.

5. The vehicle terminal of claim 1, wherein the processor is configured to change the current calling number to the reset calling number, and request a service from the service server using the reset calling number and a vehicle identification number.

6. A method of resetting a calling number preset for a vehicle terminal disposed at a vehicle, the method comprising:
requesting, from the vehicle terminal to a service server, a service provided from a service server;
receiving, at the vehicle terminal from the service server, a preset type of error code;
transmitting, from the vehicle terminal to a communication management server, a request for resetting a calling number assigned to the vehicle terminal;
receiving, at the vehicle terminal from the communication management server, a reset calling number; and
changing, by the vehicle terminal, a current calling number to the reset calling number.

7. The method of claim 6, wherein requesting a service comprises providing a vehicle identification number of the vehicle while requesting the service using the current calling number.

8. The method of claim 7, further comprising, by the service server:
searching for a prestored calling number based on the vehicle identification number in response to receiving a service request,
comparing the current calling number with the prestored calling number, and
transmitting the error code in response to determining that the current calling number and the prestored calling number do not match.

9. The method of claim 7, wherein sending a request for resetting comprises providing the vehicle identification number of the vehicle.

10. The method of claim 9, further comprising, by the communication management server:
searching a vehicle identification number-calling number look-up table based on the vehicle identification number, and
providing a prestored reset calling number matching the vehicle identification number to the vehicle terminal.

11. The method of claim 7, further comprising, before the requesting, by the vehicle terminal, a service to be provided from a service server:
transmitting, by the service server, a request for resetting a calling number related to the vehicle terminal to the communication management server in response to a service subscription/activation request;
resetting, by the communication management server, a calling number assigned to the vehicle terminal in response to the resetting request; and
providing, by the communication management server, the reset calling number to the service server.

12. The method of claim 11, wherein transmitting a request for resetting a calling number related to the vehicle terminal comprises providing the vehicle identification number of the vehicle, and
resetting a calling number comprises matching the reset calling number with the vehicle identification number and storing the matched reset calling number and vehicle identification number by the communication management server.

13. The method of claim 11, further comprising, by the service server, matching the reset calling number provided from the communication management server with the vehicle identification number and storing the matched reset calling number and vehicle identification number.

14. A system configured to reset a calling number assigned to a vehicle terminal disposed at a vehicle, the system comprising:
a service server configured to:
based on the service request being received from the vehicle terminal, determine validity of a service request, and
based on a determination that the service request is invalid, transmit a preset type of error code to the vehicle terminal; and
a communication management server configured to:
based on a request for resetting a calling number being received from the vehicle terminal, reset a calling number assigned to the vehicle terminal, and
provide the reset calling number to the vehicle terminal,
wherein the vehicle terminal is configured to, based on the error code being received from the service server, transmit a request for resetting the calling number to the communication management server, and change a current calling number to the reset calling number provided from the communication management server.

15. The system of claim 14, wherein the vehicle terminal is configured to provide a vehicle identification number of the vehicle while requesting a service from the service server using the current calling number.

16. The system of claim 15, wherein the service server is configured to:
search for a prestored calling number based on the vehicle identification number,
compare the current calling number with the prestored calling number, and
transmit, based on the current calling number and the prestored calling number not being identical, the error code.

17. The system of claim 14, wherein the vehicle terminal is configured to provide a vehicle identification number of the vehicle while sending a request for resetting the calling number to the communication management server, and
wherein the communication management server is configured to:
search a vehicle identification number-calling number look-up table based on the vehicle identification number, and
provide a prestored reset calling number matching the vehicle identification number to the vehicle terminal.

18. The system of claim 14, further comprising a user terminal configured to transmit, to the service server, a request for service subscription/activation for the vehicle terminal,
wherein the service server is configured to, based on the service subscription/activation request, transmit, to the communication management server, a request for resetting the calling number related to the vehicle terminal, and
wherein the communication management server is configured to, based on the resetting request from the service server, reset a calling number assigned to the vehicle terminal, and provide the reset calling number to the service server.

19. A vehicle comprising a vehicle terminal configured to communicate with a service server and a communication management server,
wherein, based on a preset type of error code being received from the service server after requesting a service to be provided by the service server, the vehicle terminal is configured to:
transmit a request for resetting a calling number to the communication management server,
receive a reset calling number provided from the communication management server, and
change a current calling number to the reset calling number.
